(19) United States
(12) Patent Application Publication
(10) Pub. No.: US 2026/0362555 A1
(43) Pub. Date: Nov. 12, 2026

(54) HEATING ELEMENT FOR A COOKING APPLIANCE

(71) Applicant: Haier US Appliance Solutions, Inc., Wilmington, DE (US)

(72) Inventor: Steven Bernard Froelicher, Shepherdsville, KY (US)

(21) Appl. No.: 19/203,716

(22) Filed: May 9, 2025

(51) Int. Cl. H05B 3/52; H05B 3/04

(52) U.S. Cl. CPC H05B 3/52; H05B 3/04; H05B 2203/017

(57) ABSTRACT

A heating element for a cooking appliance including a tubular sheath defining a sheath diameter, a resistive coil extending through the tubular sheath, and a cold pin electrically coupled to the resistive coil and being inserted into the tubular sheath by an insertion depth, wherein an insertion ratio equal to the insertion depth over the sheath diameter is greater than 20.

### FIELD OF THE INVENTION

The present subject matter relates generally to cooking appliances, and more particularly, to systems and methods for operating heating elements in cooking appliances.

### BACKGROUND OF THE INVENTION

Conventional residential and commercial cooking appliances generally include a cabinet that includes a cooking chamber for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber. These cooking appliances may also include one or more cooktop heater for heating cooking utensils placed on a cooktop of the appliance.

Whether heating the cooking chamber or a cooking utensil on the cooktop, heating elements are often a type of resistive heater referred to as a “Calrod®” heater. Notably, these heaters commonly experience current leakage during start-up, normal operation, and/or shut down. This current leakage results in energy inefficiency and may cause issues with the electrical supply system. For example, ground fault circuit interrupt (GFCI) breakers are now being encouraged or required for powering oven appliances. The leakage current may trip GFCI breakers to which oven appliance is electrically coupled, even when the current leakage is not dangerous.

Over time, it is possible for moisture to accumulate or settle within a Calrod electric heating element. This is especially true after extended periods of non-use. At relatively low levels, this moisture may be evaporated and driven out of the resistive heating element without issue. Significant moisture buildup (e.g., such as might occur in a vacation property or appliance that is not used for multiple weeks or months), however, can cause problems. For instance, rapid heating of moisture within the electric heating element may cause a current leakage or may otherwise disrupt an electrical current at the heating element.

Accordingly, an oven appliance with improved heating systems and methods of operation is desirable. More specifically, a heating element and system for powering the heating element with minimal current leakage would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a heating element for a cooking appliance is provided including a tubular sheath defining a sheath diameter, a resistive coil extending through the tubular sheath, and a cold pin electrically coupled to the resistive coil and being inserted into the tubular sheath by an insertion depth, wherein an insertion ratio equal to the insertion depth over the sheath diameter is greater than 20.

In another exemplary embodiment, a method of manufacturing a heating element for a cooking appliance is provided including electrically coupling a resistive coil to a cold pin and positioning the resistive coil inside a tubular sheath such that the cold pin is inserted into the tubular sheath by an insertion depth, wherein an insertion ratio equal to the insertion depth over a sheath diameter is greater than 20.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an oven appliance according to an example embodiment of the present subject matter.

FIG. 2 provides a front perspective view of the example oven appliance of FIG. 1 with a door in the open position according to an example embodiment of the present subject matter.

FIG. 3 provides a side, schematic view of the example oven appliance of FIG. 1 according to an example embodiment of the present subject matter.

FIG. 4 provides a side, schematic view of a tubular sheath heating element according to an example embodiment of the present subject matter.

FIG. 5 provides a schematic view of the example heating element of FIG. 4 powered by a wiring construction including a ground fault circuit interrupt (GFCI) breaker according to an example embodiment of the present subject matter.

FIG. 6 provides a close-up, side, schematic view of a tubular sheath heating element according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to oven heaters with long cold pins and a minimum first cycle preheat on time to reduce the GFCI faults. This method makes two changes to reduce the probability of GFCI tripping, i.e., using all heaters with long cold pins greater than 6 inches length (e.g., between about 10 inches to 16 inches) and increasing the ON time for first preheat cycle greater than 2 minutes (e.g., an ON time of 3 to 4 minutes). Further, the heater employs a longer cold pin having lower peak current leakage and more rapid dissipation of current leakage. These two changes make the heaters more robust to water ingress and better manage the water egress, when the heaters are first powered.

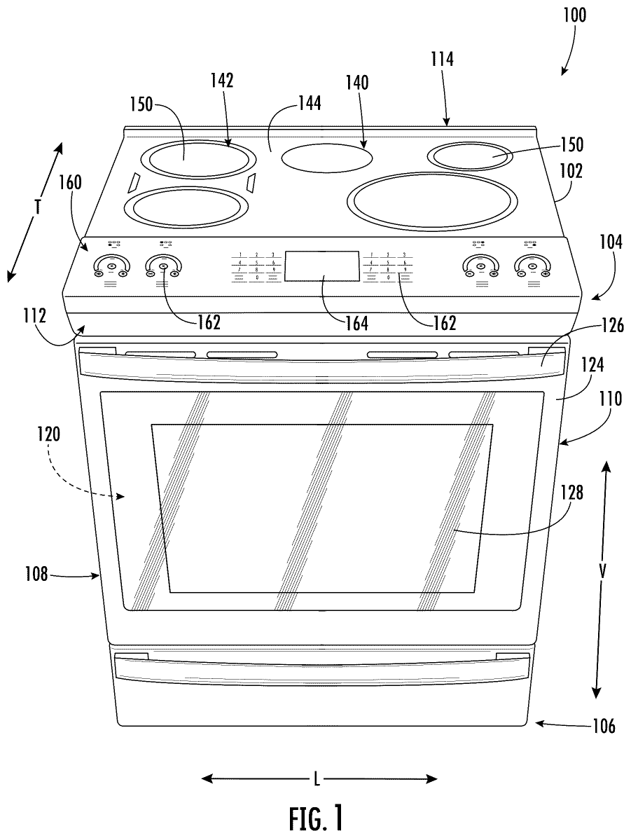

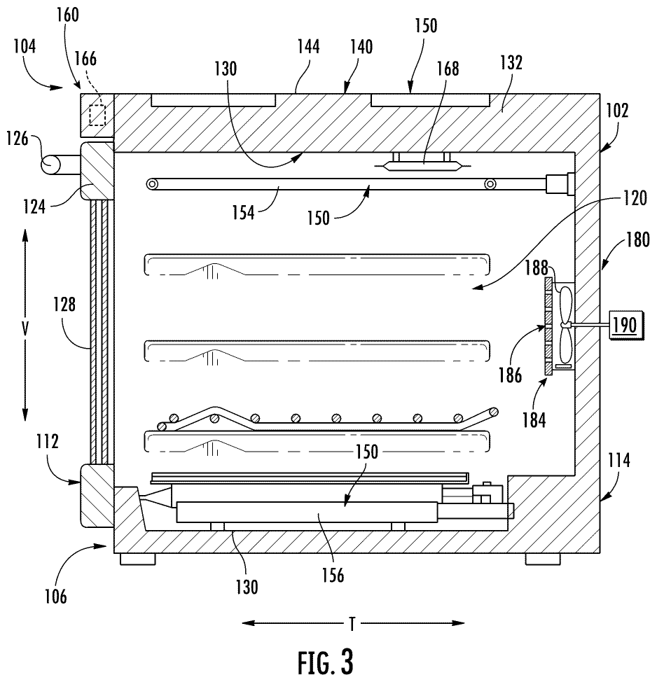

FIG. 1 provides a front, perspective view of an oven appliance 100 as may be employed with the present subject matter. Oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 (FIG. 3) along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to any suitable cooktop appliance.

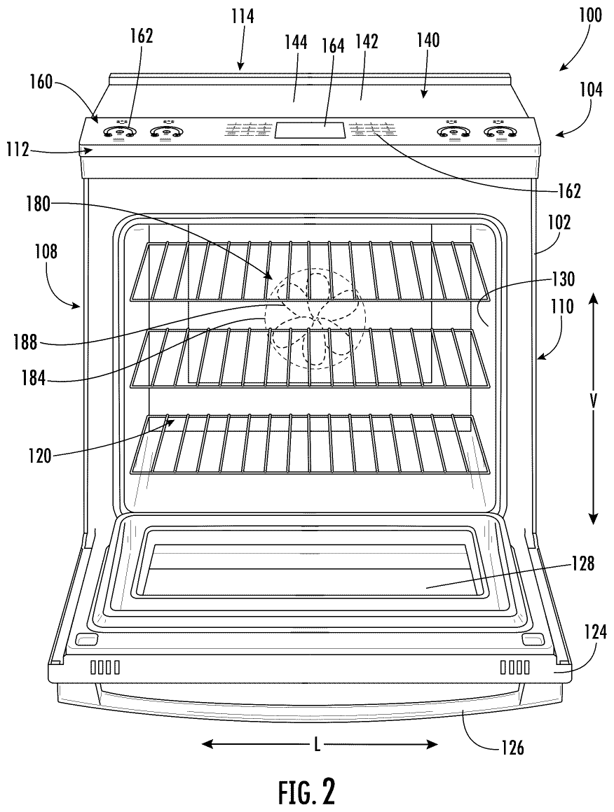

Referring now also to FIGS. 2 and 3, oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

Cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Oven appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. For example, according to the illustrated embodiment, cooktop includes a ceramic glass panel 144 having a plurality of cooking zones.

Oven appliance 100 may further include one or more heating elements (identified generally by reference numeral 150) for selectively heating cooking utensils positioned on glass panel 144 or food items positioned within cooking chamber 120. For example, referring to FIG. 1, heating elements 150 may be electric burners 150. Specifically, a plurality of electric burners 150 are mounted within or on top of top panel 142 underneath a glass panel 144 that supports cooking utensils over the electric burners 150 while electric burners 150 provide thermal energy to cooking utensils positioned thereon, e.g., to heat food and/or cooking liquids (e.g., oil, water, etc.). Electric burners 150 can be configured in various sizes so as to provide e.g., for the receipt of cooking utensils (i.e., pots, pans, etc.) of various sizes and configurations and to provide different heat inputs for such cooking utensils. According to alternative embodiments, oven appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on the, e.g., the size of oven appliance 100 or the desired heat output. Oven appliance 100 may include any other suitable number, type, and configuration of heating elements 150 within cabinet 102 and/or on cooktop 140. For example, oven appliance 100 may further include electric heating elements, induction heating elements, or any other suitable heat generating device.

Although aspects of the present subject matter are described herein in the context of a single oven appliance, it should be appreciated that oven appliance 100 is provided by way of example only. Other oven or range appliances having different configurations, different appearances, and/or different features may also be utilized with the present subject matter, e.g., double ovens, standalone cooktops, etc.

As illustrated, oven appliance 100 may generally include a user interface panel 160 that is located within convenient reach of a user of the oven appliance 100. For example, according to the illustrated embodiment, user interface panel 160 is mounted at a front 112 and top 104 corner of cabinet 102, e.g., directly above door 124. Although user interface panel 160 is illustrated as being mounted at a top, front of cabinet 102, it should be appreciated that aspects of the present subject matter may be applicable to other mounting locations of control panels, e.g., such as front mount control panels, rear mount panels, etc. In addition, it should be appreciated that the present subject matter is not limited oven applications but could instead be applied to any other suitable appliance.

For this example embodiment, user interface panel 160 includes control inputs 162 that are each associated with one of heating elements 150. In this manner, control inputs 162 allow the user to activate each heating element 150 and determine the amount of heat input provided by each heating element 150 to a cooking food items within cooking chamber 120 or on cooktop 140. Although control inputs 162 are illustrated as touch-sensitive or contact inputs, it should be understood that control inputs 162 and the configuration of oven appliance 100 shown in FIG. 1 is provided by way of example only. More specifically, user interface panel 160 may include various input components, such as one or more of a variety control knobs, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

User interface panel 160 may be in direct operative communication with a controller 166 of oven appliance 100, such that user inputs via user interface panel 160 may be directly used to regulate operation of various components of oven appliance 100. User interface panel 160 of oven appliance 100 may be in communication with controller 166 via, for example, one or more signal lines or shared communication busses, and signals generated in controller 166 operate oven appliance 100 in response to user input via user input devices 162. Input/Output (“I/O”) signals may be routed between controller 166 and various operational components of oven appliance 100 such that operation of oven appliance 100 can be regulated by controller 166.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In addition, controller 166 may also be communication with one or more sensors, such as temperature sensor 168 (FIG. 3), which may be used to measure temperature inside cooking chamber 120 and provide such measurements to the controller 166. As used herein, “temperature sensor” or the equivalent is intended to refer to any suitable type of temperature measuring system or device positioned at any suitable location for measuring the desired temperature. Thus, for example, temperature sensor 168 may each be any suitable type of temperature sensor, such as a thermistor, a thermocouple, a resistance temperature detector, a semiconductor-based integrated circuit temperature sensor, etc. In addition, temperature sensor 168 may be positioned at any suitable location and may output a signal, such as a voltage, to a controller that is proportional to and/or indicative of the temperature being measured. Although exemplary positioning of temperature sensors is described herein, it should be appreciated that oven appliance 100 may include any other suitable number, type, and position of temperature and/or other sensors according to alternative embodiments.

In some embodiments, oven appliance 100 includes a convection heating assembly 180 that operates in conjunction with chamber heating elements (e.g., heating elements 154, 156) to facilitate convection cooking within cooking chamber 120. In this regard, convection heating assembly 180 may operate to circulate a flow of heated air within cooking chamber 120 to facilitate more even heating and shorter cooking cycle times. Although an example convection heating assembly 180 is described below, it should be appreciated that variations and modifications may be made while remaining within the scope of the present subject matter.

As best shown in FIGS. 2 and 3, convection heating assembly 180 includes a convection fan enclosure 184 positioned proximate a rear of cooking chamber 120. In this regard, convection fan enclosure 184 is defined at least partially by a front wall and a rear wall spaced apart along the transverse direction T. Fan enclosure 184 may define one or more apertures 186 that permit the flow of heated air to pass into and out of convection fan enclosure 184. According to alternative example embodiments, convection fan enclosure 184 may include alternative airflow paths, ducts, or other flow regulating devices for directing the flow of heated air within convection fan enclosure 184 and throughout cooking chamber 120.

As illustrated, convection heating assembly 180 further includes a convection fan 188 mounted in cabinet 102 (e.g., within convection fan enclosure 184) for circulating the flow of heated air in cooking chamber 120. Specifically, convection fan 188 is illustrated as a centrifugal fan, though other suitable fan types and configurations are possible and within the scope of the present subject matter. A drive motor 190 may be mounted to cabinet 102 and may be mechanically coupled to convection fan 188 for selectively rotating convection fan 188. Drive motor 190 may be a single direction motor configured to rotate convection fan 188 in a single direction. Notably, as explained above, using a single direction drive motor 190 and rotating convection fan 188 in a single direction may minimize costs and system complexity.

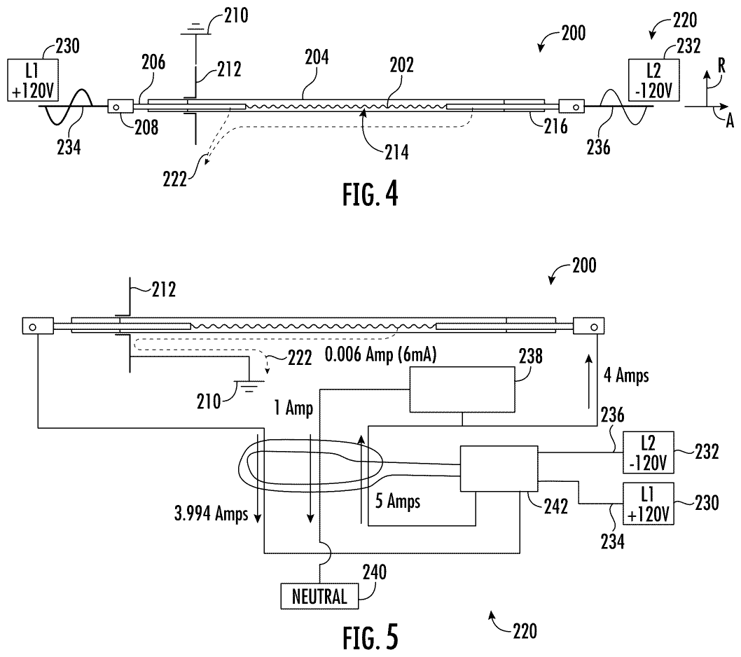

In general, tubular or sheathed heating elements, often referred to by their brand name as “Calrod®” heaters, may be used as bake heaters, broil heaters, convection heaters, cooktop heating elements, etc. in cooking appliances. While the specific construction of such heaters may vary, an example construction of such a heating element 200 is illustrated in FIG. 4. It should be appreciated that aspects of the present subject matter are not limited to the specific construction of heating element 200 as shown and described herein. In addition, it should be appreciated that heating element 200 may be included as or as part of any one of heating elements 154, 156, or 150 as described above in the context of oven appliance 100.

As shown in FIG. 4, these heating elements 200 commonly include a heating element or resistive coil 202 (e.g., a fine coil of resistive wire) positioned within an external metallic tube or tubular sheath 204. Tubular sheath 204 is formed as a generally solid or non-permeable metal structure that does not permit the passage of liquids, such as water. Tubular sheath 204 may be constructed of or with a suitable thermally conductive metal material. For example, tubular sheath 204 may be constructed of steel, aluminum (including alloys of steel or aluminum). For example, resistive coil 202 and tubular sheath 204 may generally extend along an axial direction A and a radial direction R may be defined perpendicular to the axial direction A. Although shown as a generally straight member, it is understood that heating element 200 may be formed into any suitable shape. For example, heating element 200 may generally be U-shaped, circular, arcuate, have multiple coils, etc.

Cold pins 206 may extend through the ends of tubular sheath 204 and may be electrically coupled to resistive coil 202. These cold pins 206 are often terminated in electrical terminals 208 to facilitate the application of voltage across the resistive coil 202 and to facilitate operation of the heating element 200. Generally, resistive coil 202 is disposed within the enclosed volume of tubular sheath 204 to generate heat in response to an electrical current. When assembled, resistive coil 202 may be electrically coupled to a voltage source (described below) or controller 166, e.g., via cold pins 206. In some embodiments, resistive coil 202 includes or is provided as a resistive wire formed from a suitable high-resistance material, such as nichrome (i.e., a nickel-chromium alloy), ferrochrome (i.e., an iron-chromium alloy), etc.

In addition, one end of tubular sheath 204 is commonly connected to an electrical ground 210, e.g., using a ground plate 212. For instance, ground plate 212 may extend radially (e.g., outward) from tubular sheath 204. Moreover, ground plate 212 may be disposed in conductive communication with tubular sheath 204. In some embodiments, a friction fit or crimping joint may secure ground plate 212 to tubular sheath 204 or heating element 200 generally. In this manner, if resistive coil 202 or the cold pins 206 accidentally touch tubular sheath 204, current may be grounded instead of potentially shocking the appliance user.

Referring still to FIG. 4, tubular sheath 204 may be filled with a dielectric insulation material 214, such as Magnesium Oxide (MgO), e.g., to prevent electrical contact between tubular sheath 204 and either resistive coil 202 or cold pins 206. In addition, moisture end seals 216 may be positioned at the ends of tubular sheath 204 to contain the MgO 214 and regulate the presence of moisture within heating element 200. In some embodiments, one or more moisture end seals 216 are disposed at the ends of tubular sheath 204. Each moisture end seals 216 may be formed from any suitable insulating material to limit or restrict conducted heat and/or electricity from passing from tubular sheath 204 (e.g., silicone rubber) through moisture end seals 216.

To manufacture a sheath heater, such as heating element 200, the tubular sheath 204 may be oriented vertically with a lower moisture end seal 216 and cold pin 206 installed on a bottom of the tubular sheath 204. The heating coil 202 is attached to the lower cold pin 206 and is suspended upright in the middle of the tubular sheath 204. The dielectric insulator 214, e.g., such as MgO is then filled from a top end of the tubular sheath 204 while the tubular sheath 204 is vibrated to ensure proper filling of MgO. Once filled, the MgO holds the cold pins 206 and the heating coil 202 in the center of the tubular sheath 204 while acting as a dielectric insulator 214 and a thermal conductor. The top cold pin 206 and upper moisture end seal 216 are installed to contain the MgO and complete the manufacture of the tubular sheath heating element 200.

Notably, heating element 200 may experience current leakage during start-up, normal operation, and/or shut down. While the current leakage may vary depending on heater operation and/or wiring configurations, the current leakage results in energy inefficiency and may cause issues with the electrical supply system 220, which is illustrated schematically in FIG. 5. For example, this current leakage (e.g., identified by reference numeral 222) may trip ground fault circuit interrupt (GFCI) breakers 242 to which cooking appliance 100 is electrically coupled.

In this regard, electrical supply system 220 for powering heating element 200 may include a first supply source 230 that supplies electrical power at a first voltage (e.g., positive 120 VAC) and a second supply source 232 that supplies electrical power at a second voltage (e.g., negative 120 VAC). In this regard, the supply sources 230, 232 may be set at inverse phases (e.g., such that the phases of currents from the supply sources 230, 232 may be inverse from each other). Thus, the first supply source 230 may be set according to one phase (e.g., positive) while the second supply source 232 may be set according to an opposite phase (e.g., negative) such that currents therefrom may alternate. The absolute value of the voltage of the currents supplied from the supply sources 230, 232 may be configured as any suitable voltage (e.g., the same absolute value). Optionally, the first supply source 230 is set at approximately 120 Volts (i.e., between 103 Volts and 130 Volts) while the second supply source 232 is set at approximately 120 Volts. During operation, when the current from the first supply source 230 is supplied at (+) 120 V, the current from the second supply source 232 may be supplied at (−) 120 V.

First supply source 230 may be electrically coupled to a first supply line or leg (referred to herein as a first line 234) and second supply source 232 may be electrically coupled to a second supply line or leg (referred to herein as a second line 236). As illustrated, first line 234 and second line 236 may be electrically coupled to electrical terminals 208 on opposite ends of heating element 200, such that 240 VAC is applied across resistive coil 202. Optionally, one or more additional appliance components 240 (e.g., light diodes, displays, etc.) may be connected to only one of the supply sources 230, 232 (e.g., second supply source 232), such as between the connected voltage source and a neutral line 240. In turn, such components 240 may only receive an electrical current from one of the pair of supply sources 230, 232.

In optional embodiments, a ground fault circuit interrupter (GFCI) 242 is provided along one or both of the supply sources 230, 232. For instance, the GFCI 242 may connect to and be disposed along the first line 234 and the second line 236. As would be understood, the GFCI 242 may include a sensor configured to monitor for (i.e., detect) current leakages (e.g., as measured in Amperes) through one or more lines, such as first line 234, second line 236, or neutral line 240. In particular, the GFCI 242 may be configured or set to detect imbalances in a current through the monitored lines (e.g., according to a predetermined imbalance value). Detection of an imbalance value above the predetermined imbalance value may thus cause the GFCI 242 to trip, thus opening the circuit to first line 234 or the second line 236.

Current leakage in a Calrod electric heating element (such as heating element 200) may occur due to a variety of reasons. For example, the applied voltage may go from an out-of-phase condition to an in-phase condition along the length of the heating element. In addition, or alternatively, transient moisture that is absorbed in the MgO may be escaping. In this regard, moisture absorption into the MgO during periods of nonuse can cause short duration current leakage in the heating element while the moisture is being driven out when the heating element is energized and heating. Moreover, the MgO may have a higher electrical conductivity due to a high sheath temperature at the time of cycling the power off. As noted above, this current leakage is undesirable and should be minimized or eliminated altogether.

Notably, it has been discovered that water has a tendency to enter the tubular sheath, particularly during long periods of non-use. For example, it is typical that moisture ingress around the moisture end seals enters into the MgO dielectric insulator. The moisture is transient in nature as it will be driven off when power is applied to the heater. However, it is possible for the moisture to facilitate leakage current to ground. For example, this current leakage may be of a magnitude that could potentially trip a GFCI circuit breaker.

Over time and without use, water ingress at each end of the tubular sheath heating element is possible. It is likely that the water concentration will be highest at each end of the heater, but this moisture will gradually move towards the center of the heater. As the heater power drives the water out of the heater, the water may temporarily be concentrated at the ends of the heater, e.g., mostly in the “cold pin” area of the heating element. The higher concentration of water leads to higher current leakage and thus a higher likelihood of tripping a GFCI circuit breaker.

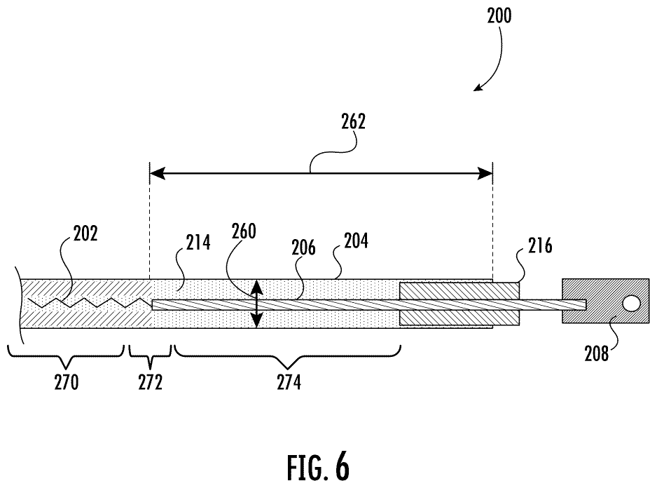

Referring now to FIG. 6, an example construction of heating element 200 will be described which reduces the effects of water ingress and the associated current leakage. In this regard, it has been discovered that lengthening the cold pins 206 may result in a favorable reduction of current leakage in heating element 200. In this regard, for example, tubular sheath 204 may define a sheath diameter 260 and cold pin(s) 206 can be inserted into tubular sheath 204 by an insertion depth 262. An insertion ratio of the heating element is defined as the insertion depth over the sheath diameter. By carefully regulating the insertion ratio of a given heating element 200, it has been discovered that current leakage may be reduced.

According to an example embodiment, sheath diameter 260 is between about 0.05 and 1 inches, between about 0.1 and 0.5 inches, between about 0.2 and 0.3 inches, or about 0.26 inches. According to an example embodiment, insertion depth 262 is between about 5 and 25 inches, between about 10 and 16 inches, between about 12 and 14 inches, or about 13 inches. According to an example embodiment, the insertion ratio may be between about 5 and 50, between about 10 and 40, between about 15 and 35, greater than 20, greater than 30, or greater.

Without being limited to any particular theory, it is believed that the specific sheath diameters 260, insertion depths 262, and/or insertion ratios described above reduce current leakage, which is best explained using three distinct “zones” of heating element 200. Specifically, each end of heating element 200 may include a first zone 270 (which primarily includes resistive coil 202), a second zone 272 (which is a transition region where resistive coil 202 meets cold pins 206), and a third zone 274 (which primarily includes the region between second zone 272 and end seals 216). An example explanation of the causes of current leakages and the benefits of the present construction are provided below with reference to these zones.

In first zone 270, moisture is slowly absorbed within tubular sheath 204 and by MgO during extended off times. However, this moisture is rapidly ejected from first zone 270 when heating element 200 is energized, e.g., due to the large amount of heat introduced. When this happens, a high pressure and high concentration wave of water vapor is driven towards the cold pins 206 as it attempts to escape tubular sheath 204. In second zone 272, rapidly escaping vapor may compress and condense at the end of the cold pin 206, causing a temporary drop in the dielectric properties of the MgO, and thus resulting in current leakage. Third zone 274 acts as a secondary seal against water ingress during off times of heating element and may act as a benign water vapor deposition volume during heating due to the lower internal temperature relative to first zone 270 and second zone 272. Sizing third zone 274 as described above with longer insertion depths 262 and insertion ratios may limit water ingress during off times and provide a larger dissipation volume when heating element is energized.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A heating element for a cooking appliance, the heating element comprising:
a tubular sheath defining a sheath diameter;
a resistive coil extending through the tubular sheath; and
a cold pin electrically coupled to the resistive coil and being inserted into the tubular sheath by an insertion depth, wherein an insertion ratio equal to the insertion depth over the sheath diameter is greater than 20.

2. The heating element of claim 1, wherein the insertion ratio is greater than 30.

3. The heating element of claim 1, wherein the sheath diameter is between about 0.1 and 0.5 inches.

4. The heating element of claim 1, wherein the sheath diameter is between about 0.2 and 0.3 inches.

5. The heating element of claim 1, wherein the insertion depth is between about 10 and 16 inches.

6. The heating element of claim 1, wherein the insertion depth is between about 12 and 14 inches.

7. The heating element of claim 1, wherein an electric terminal is attached to a distal end of the cold pin.

8. The heating element of claim 1, further comprising:
a ground terminal connected to the tubular sheath of the heating element.

9. The heating element of claim 1, further comprising:
an end seal positioned at an end of the tubular sheath, the cold pin passing through a center of the end seal.

10. The heating element of claim 1, further comprising:
a dielectric insulator that is poured into the tubular sheath.

11. The heating element of claim 10, wherein the dielectric insulator is Magnesium Oxide (MgO).

12. The heating element of claim 1, wherein the cold pin is a first cold pin connected to a first end of the resistive coil, the heating element further comprising:
a second cold pin electrically coupled to a second end of the resistive coil and being inserted into the tubular sheath by a second insertion depth, wherein a second insertion ratio equal to the second insertion depth over the sheath diameter is greater than 20.

13. A method of manufacturing a heating element for a cooking appliance, the method comprising:
electrically coupling a resistive coil to a cold pin; and
positioning the resistive coil inside a tubular sheath such that the cold pin is inserted into the tubular sheath by an insertion depth, wherein an insertion ratio equal to the insertion depth over a sheath diameter is greater than 20.

14. The method of claim 13, further comprising:
filling the tubular sheath with a dielectric insulator.

15. The method of claim 13, further comprising:
positioning an end seal at an end of the tubular sheath, the cold pin passing through a center of the end seal.

16. The method of claim 13, wherein the insertion ratio is greater than 30.

17. The method of claim 13, wherein the sheath diameter is between about 0.1 and 0.5 inches.

18. The method of claim 13, wherein the sheath diameter is between about 0.2 and 0.3 inches.

19. The method of claim 13, wherein the insertion depth is between about 10 and 16 inches.

20. The method of claim 13, wherein the insertion depth is between about 12 and 14 inches.
